(19) United States
(12) Patent Application Publication
(10) Pub. No.: US 2016/0277351 A1
(43) Pub. Date: Sep. 22, 2016

(54) SYSTEMS AND METHODS FOR PROVIDING NOTIFICATIONS BASED ON SUBJECT SUBSCRIPTION

(71) Applicant: Facebook, Inc., Menlo Park, CA (US)

(72) Inventors: Zhiyang Wang, Mountain View, CA (US); Yushuang Dong, Mountain View, CA (US); Gautam Sewani, Menlo Park, CA (US); Zhongyuan Xu, Sunnyvale, CA (US)

(21) Appl. No.: 14/664,500

(22) Filed: Mar. 20, 2015

(51) Int. Cl. H04L 12/58; G06F 17/30

(52) U.S. Cl. CPC H04L 51/32; H04L 51/24; G06F 17/30601; G06F 17/30589

(57) ABSTRACT

Systems, methods, and non-transitory computer-readable media can identify a resource provided via a social networking system. A request for a user account to subscribe to a subject that is presentable via the resource can be received. The subject can be included in a set of subjects available for subscription by the user account. It can be determined that a post associated with the subject has been presented via the resource. A notification indicating that the post associated with the subject has been presented via the resource can be provided to the user account.

### FIELD OF THE INVENTION

The present technology relates to the field of providing content. More particularly, the present technology relates to techniques for providing notifications based on subject subscription.

### BACKGROUND

Today, people often utilize computing devices (or systems) for a wide variety of purposes. Users can use their computing devices to, for example, interact with one another, create content, share information, and access information. In some instances, a user of a computing device can utilize a social networking system (or service) to post, publish, share, or otherwise provide content, such as text, images, or videos.

In some cases, large amounts of content can be posted to the social networking system. In one example, a particular user of the social networking system can be presented with a multitude of content items provided from various posters or other sources. Under conventional approaches to providing content, it can often times be difficult or inconvenient for the particular user to sift through the multitude of content items to locate certain content items that may be especially relevant to the particular user. Furthermore, in accordance with conventional approaches, it can be inefficient and time-consuming for the particular user to locate those content items that he or she desires to access or view. As such, conventional approaches can be inconvenient, inefficient, and costly. Due to these and other reasons, conventional approaches can create challenges for or reduce the overall user experience associated with utilizing social networking systems to access provided content.

### SUMMARY

Various embodiments of the present disclosure can include systems, methods, and non-transitory computer readable media configured to identify a resource provided via a social networking system. A request for a user account to subscribe to a subject that is presentable via the resource can be received. The subject can be included in a set of subjects available for subscription by the user account. It can be determined that a post associated with the subject has been presented via the resource. A notification indicating that the post associated with the subject has been presented via the resource can be provided to the user account.

In an embodiment, receiving the request for the user account to subscribe to the subject can further comprise receiving one or more inputted characters. At least one of a defined topic or an entity can be provided based on the one or more inputted characters. A selection for at least one of a keyword including the one or more inputted characters, the defined topic, or the entity can be received. The request for the user account to subscribe to the subject can be based on the selection.

In an embodiment, determining that the post associated with the subject has been presented via the resource can further comprise determining that the post is associated with the at least one of the keyword including the one or more inputted characters, the defined topic, or the entity.

In an embodiment, determining that the post is associated with the at least one of the keyword including the one or more inputted characters, the defined topic, or the entity can further comprise determining that the post is associated with at least one of a string representing the keyword, a subtopic specified as being included with the defined topic, or an identifier for the entity.

In an embodiment, a subset of the set of subjects available for subscription by the user account can be presented via the resource. One or more subjects, out of the subset, to which the user account has subscribed can be identified.

In an embodiment, one or more subjects in the set of subjects are based on a category of the resource.

In an embodiment, one or more subjects in the set of subjects are specified by the resource.

In an embodiment, the resource can include at least one of a page within the social networking system, a group within the social networking system, an event within the social networking system, or an application within the social networking system.

In an embodiment, the notification is provided via at least one of the social networking system or a message system. The notification can provide at least one of access to the post or access to a portion of the resource that presents the post.

In an embodiment, the notification can be provided in real-time.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example subject subscription module configured to facilitate providing notifications based on subject subscription, according to an embodiment of the present disclosure.

FIG. 2A illustrates an example subject module configured to facilitate providing notifications based on subject subscription, according to an embodiment of the present disclosure.

FIG. 2B illustrates an example post module configured to facilitate providing notifications based on subject subscription, according to an embodiment of the present disclosure.

FIG. 3 illustrates an example scenario associated with providing notifications based on subject subscription, according to an embodiment of the present disclosure.

FIG. 4 illustrates an example scenario associated with providing notifications based on subject subscription, according to an embodiment of the present disclosure.

FIG. 5 illustrates an example method associated with providing notifications based on subject subscription, according to an embodiment of the present disclosure.

FIG. 6 illustrates an example method associated with providing notifications based on subject subscription, according to an embodiment of the present disclosure.

FIG. 7 illustrates a network diagram of an example system including an example social networking system that can be utilized in various scenarios, according to an embodiment of the present disclosure.

FIG. 8 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Providing Notifications Based on Subject Subscription

People use computing devices (or systems) for a wide variety of purposes. Computing devices can provide different kinds of functionality. Users can utilize their computing devices to produce information, access information, and share information. In some instances, users of computing devices can access a social networking system (or service) to establish connections, communicate, and interact with one another via the social networking system. Users can also provide, edit, share, or access content items such as text, notes, status updates, links, pictures, videos, and audio. In one example, a user of the social networking system can post or publish a content item, which can be provided or presented on a profile page, such as on the user's timeline or on another user's timeline. In another example, the content item can be provided or presented through a feed, such as a newsfeed, for the user or for another user to view and access.

In some cases, the social networking system can have a large quantity of users, which can result in a large amount of content being posted, published, or provided. Often times, in accordance with conventional approaches, a multitude of content items can be provided, presented, or surfaced to a particular user of the social networking system. However, under conventional approaches, if the particular user is interested in certain content items, it can be inconvenient or difficult for the particular user to locate or be aware of those content items within the multitude of content items provided to him or her. Moreover, some content items that may be of interest to the particular user can be time-sensitive, in that those content items may be relevant to the particular user only within a particular duration of time. Yet with conventional approaches, it can be challenging for the particular user to locate those content items within the duration of time. Further, under conventional approaches, the particular user may not be aware of the existence of new content items that are interesting or relevant to the particular user.

As such, conventional approaches can be inconvenient, inefficient, and/or costly. Therefore, an improved approach can be beneficial for addressing or alleviating various concerns associated with conventional approaches. The disclosed technology can provide notifications based on subject subscription. Various embodiments of the present disclosure can identify a resource provided via a social networking system. A request for a user account to subscribe to a subject that is presentable via the resource can be received. The subject can be included in a set of subjects available for subscription by the user account. It can be determined that a post associated with the subject has been presented via the resource. A notification indicating that the post associated with the subject has been presented via the resource can be provided to the user account. It is contemplated that there can be many variations and/or other possibilities.

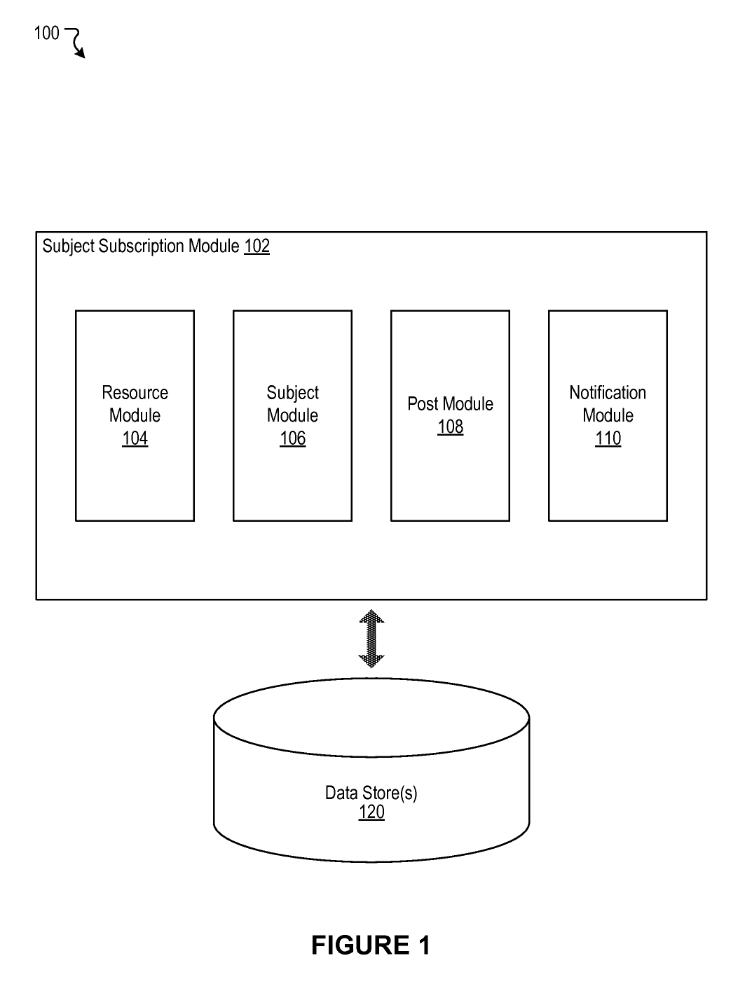

FIG. 1 illustrates an example system 100 including an example subject subscription module 102 configured to facilitate providing notifications based on (i.e., based at least in part on) subject subscription, according to an embodiment of the present disclosure. As shown in the example of FIG. 1, the subject subscription module 102 can include a resource module 104, a subject module 106, a post module 108, and a notification module 110. In some instances, the example system 100 can include at least one data store 120. The components (e.g., modules, elements, etc.) shown in this figure and all figures herein are exemplary only, and other implementations may include additional, fewer, integrated, or different components. Some components may not be shown so as not to obscure relevant details.

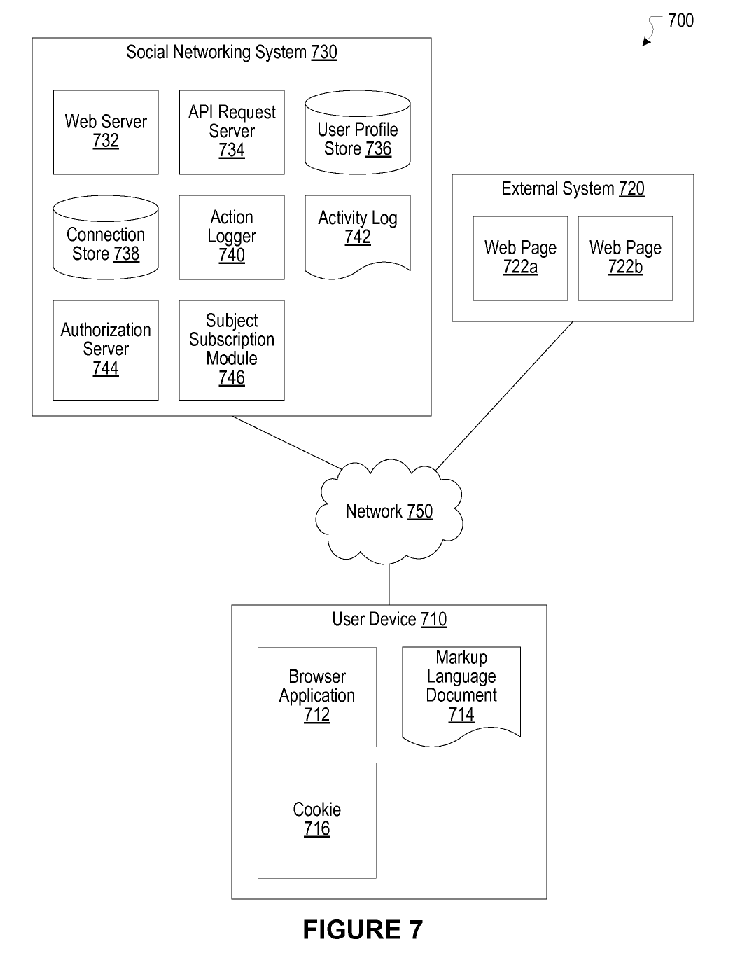

In some embodiments, the subject subscription module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the subject subscription module 102 can be implemented, in part or in whole, as software running on one or more computing devices or systems, such as on a user or client computing device. For example, the subject subscription module 102 or at least a portion thereof can be implemented as or within an application (e.g., app), a program, or an applet, etc., running on a user computing device or a client computing system, such as the user device 710 of FIG. 7. In another example, the subject subscription module 102 or at least a portion thereof can be implemented using one or more computing devices or systems that include one or more servers, such as network servers or cloud servers. In some instances, the subject subscription module 102 can, in part or in whole, be implemented within or configured to operate in conjunction with a social networking system (or service), such as the social networking system 730 of FIG. 7. It should be understood that there can be many variations or other possibilities.

The resource module 104 can be configured to facilitate identifying a resource provided via the social networking system. The resource provided within the social networking system can refer to any service, site, interface, program, assemblage, concept, etc., that is provided via the social networking system. In some instances, an example of a resource provided via the social networking system can include, but is not limited to, a page within the social networking system, a group within the social networking system, an event within the social networking system, and/or an application within the social networking system.

In one example, the resource module 104 can identify a page that is being visited, viewed, accessed, or otherwise interacted with by a particular user or user account of the social networking system. In this example, the page can be associated with an entity, such as a brand, a store, a restaurant, or a public figure. In another example, the resource module 104 can identify a group (or a virtual representation thereof) within the social networking system. In some cases, the particular user or user account can be a member or a potential member of the group. In this example, when the particular user or user account accesses a group page, member interface, or other representation of the group within the social networking system, the resource module 104 can identify the group as the resource. In a further example, the resource module 104 can identify an event (or a virtual representation thereof) within the social networking system for which the particular user or user account has been invited or is a host. In this example, when the particular user or user account accesses an event page, RSVP interface, or other representation of the event within the social networking system, the resource module 104 can identify the event as the resource. It is contemplated that there can be many variations or other possibilities.

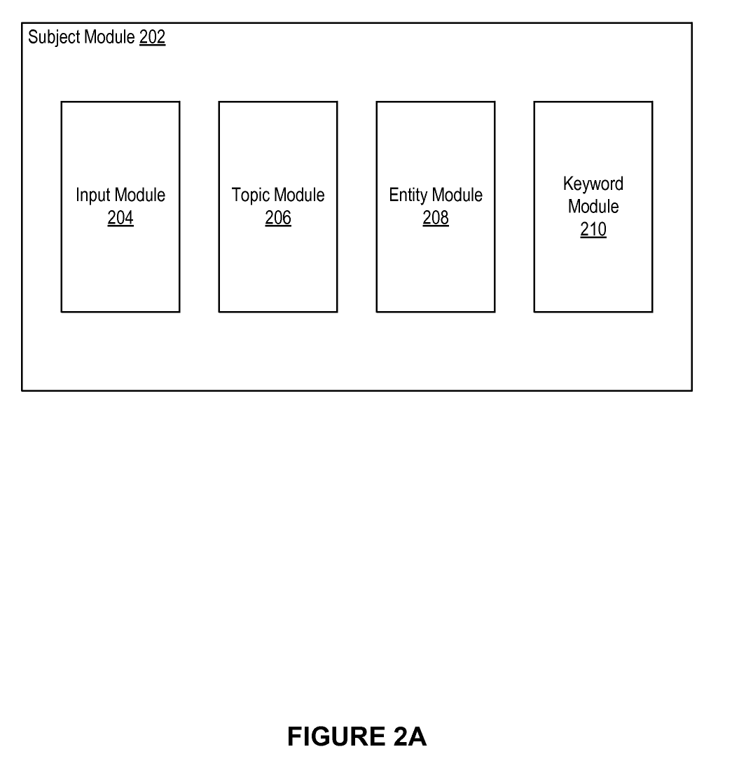

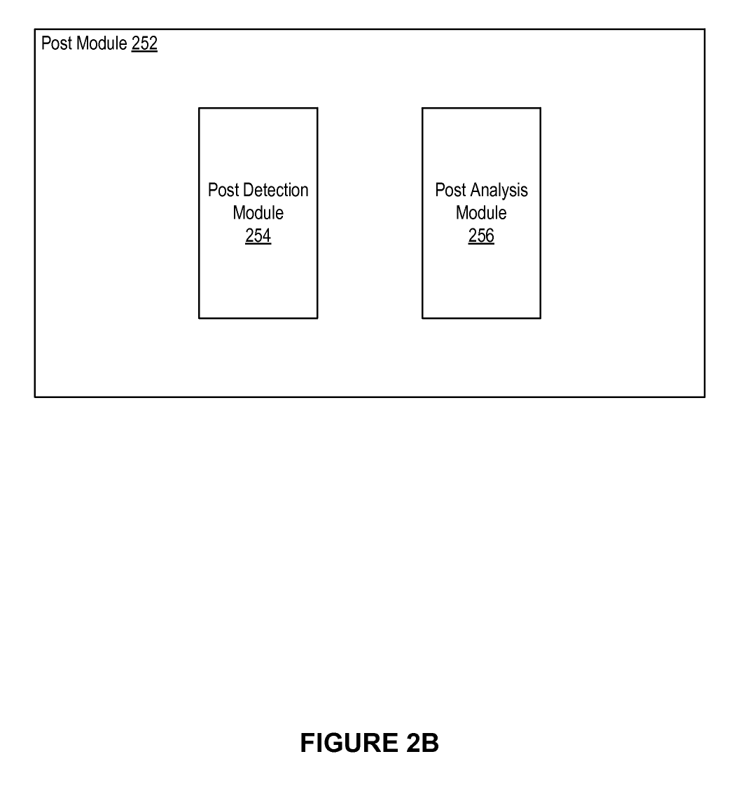

Moreover, the subject module 106 can be configured to facilitate receiving a request for a user account to subscribe to a subject that is presentable via the resource. The subject can be included in a set of subjects available for subscription by the user account. In one example, the resource can present or provide a list of topics, entities, keywords, or other subjects to which the user account (i.e., a user associated with the user account) can subscribe. In this example, the user account can select a particular subject from the list, which can initiate the request for the user account to subscribe to the particular subject. More details regarding the subject module 106 will be provided below with reference to FIG. 2A.

The post module 108 can be configured to facilitate determining that a post associated with the subject has been presented via the resource. For instance, the post module 108 can detect that a content item that references, tags, discusses, or otherwise relates to the subject has been posted, shared, or made available at the resource. The post module 108 will be discussed in more detail with reference to FIG. 2B.

In addition, the notification module 110 can be configured to facilitate providing to the user account a notification indicating that the post associated with the subject has been presented via the resource. In some embodiments, the notification can be provided in (or near) real-time. For instance, within an allowable time duration of determining that the post associated with the subject has been presented via the resource, the notification can be provided to the user account by the notification module 110.

Also, in some implementations, the notification module 110 can cause the notification to be provided via at least one of the social networking system or a message system. In one example, the notification can be provided using a notification system of the social networking system. In another example, the notification can be provided using an electronic message (e.g., e-mail) system, a text (e.g., SMS) messaging system, or a messaging system of the social networking system. Further, in some embodiments, the notification module 110 can cause the notification to provide at least one of access to the post or access to a portion of the resource that presents the post. In one example, when the user (i.e., the user account) clicks on, taps on, or otherwise interacts with the notification, the user can be navigated to or given access to the post. In another example, when the user clicks on, taps on, or otherwise interacts with the notification, the user can be navigated to or given access to a portion of the resource that presents the post. It should be understood that the examples provided herein are for illustrative purposes and that many variations are possible.

Furthermore, in some implementations, the subject subscription module 102 can be configured to communicate and/or operate with the at least one data store 120, as shown in the example system 100. The at least one data store 120 can be configured to store and maintain various types of data. In some implementations, the at least one data store 120 can store information associated with the social networking system (e.g., the social networking system 730 of FIG. 7). The information associated with the social networking system can include data about users, social connections, social interactions, locations, geo-fenced areas, maps, places, events, pages, groups, posts, communications, content, feeds, account settings, privacy settings, a social graph, and various other types of data. In some implementations, the at least one data store 120 can store information associated with users, such as user identifiers, user information, profile information, user locations, user specified settings, content produced or posted by users, and various other types of user data. In some embodiments, the at least one data store 120 can store information that is utilized by the subject subscription module 102. For instance, the at least one data store 120 can store information about subjects. It is contemplated that there can be many variations or other possibilities.

In one example, a particular user associated with a particular user account can view a page resource (i.e., page) established by or associated with a local restaurant. In this example, the resource module 104 can identify the page of the local restaurant. The particular user can be interested in posts about deals or coupons for the local restaurant. As such, the particular user can initiate a request to subscribe to a “deals” topic available at the page of the local restaurant. The request to subscribe to the “deals” topic can be received by the subject module 106. The post module 108 can detect when the local restaurant's page (or a representative thereof) has posted content associated with the “deals” topic. As a result, the particular user or user account can be provided with a notification by the notification module 110. Moreover, in some cases, the subject subscription module 102 can also utilize a system (e.g., a topic tagger system, a topic definition system, a topic relation system, an entity recognition system, an entity identification system, etc.) that determines which posts or content items are associated with a given subject. Accordingly, in this example, when content about a deal, sale, coupon, and/or discount, etc., is posted at the page, the notification can be provided to the particular user or user account. As discussed, there can be many variations or other possibilities.

FIG. 2A illustrates an example subject module 202 configured to facilitate providing notifications based on subject subscription, according to an embodiment of the present disclosure. In some embodiments, the subject module 106 of FIG. 1 can be implemented as the example subject module 202. As shown in FIG. 2A, the subject module 202 can include an input module 204, a topic module 206, an entity module 208, and a keyword module 210.

As discussed previously, the subject module 202 can be configured to facilitate receiving a request for a user account to subscribe to a subject that is presentable via a resource of a social networking system. In some implementations, receiving the request for the user account to subscribe to the subject can further comprise receiving one or more inputted characters, providing a defined topic and/or an entity based on (i.e., based at least in part on) the inputted characters, and receiving a selection for a keyword, the defined topic, and or the entity.

In some embodiments, the subject module 202 can utilize, at least in part, the input module 204 to facilitate receiving the one or more inputted characters. For example, the user account (or a user associated with the user account) can input one or more characters, which are received by the input module 204. In some cases, based on the one or more inputted characters, a defined topic can be provided by the topic module 206. In some cases, based on the one or more inputted characters, an entity can be provided by the entity module 208. Continuing with the example, when the user inputs the characters, one or more subjects (e.g., topics, entities, etc.) that include or correspond to the inputted characters can be provided to the user. In some instances, the input module 204 can provide a search bar or a text input field to receive the characters. The topic module 206 can provide, suggest, present, or list one or more defined topics (if any) that correspond to the inputted characters, while the entity module 208 can provide, suggest, present, or list one or more entities (if any) that correspond to the inputted characters. In this example, the user can select a provided defined topic or a provided entity, or the user can utilize the inputted characters to select a keyword that includes or is formed by the inputted characters. The keyword module 210 can detect when the user has utilized the inputted characters to select a keyword. As such, the subject module 202 can receive a selection for at least one of the keyword including the one or more inputted characters, the defined topic, or the entity. Further, the request for the user account to subscribe to the subject can be based on the selection. The selected topic, entity, or keyword can correspond to the subject, and the selection can initiate or generate the request for the user account to subscribe to the subject. In another example, the user can directly select a provided subject (e.g., topic, entity, etc.). The subject can, for instance, be created and provided by an admin or representative of the resource. Many variations are possible.

Furthermore, the subject to which the user account is requesting to subscribe can be included in a set of subjects available for subscription by the user account. In some embodiments, the subject module 202 can present, via the resource, a subset of the set of subjects available for subscription by the user account. In one example, the subject can be presented in an upper interface portion of the resource, such as in a top area of a page. Moreover, the subject module 202 can identify one or more subjects, out of the subset, to which the user account has subscribed. For instance, each of the one or more subjects to which the user account has already been subscribed can be labeled or presented with a checkmark or other graphical indication.

Additionally, in some embodiments, one or more subjects in the set of subjects can be based on a category of the resource. For example, a resource for a restaurant or a store can provide a “deals” topic as a subject, while a resource for a musical group can provide a “concert’ topic as a subject. In another example, a resource for an entity can provide the entity or a representation thereof as a subject. In some cases, each topic or entity can correspond to an entry of an online library, such as an online encyclopedia.

Also, in some implementations, one or more subjects in the set of subjects can be specified by the resource. For instance, the resource (or a representative thereof, an admin/administrator thereof, etc.) can define, choose, customize, or otherwise specify one or more subjects available for subscription by user accounts. It should be appreciated that many variations are possible.

FIG. 2B illustrates an example post module 252 configured to facilitate providing notifications based on subject subscription, according to an embodiment of the present disclosure. In some embodiments, the post module 108 of FIG. 1 can be implemented as the example post module 252. As shown in FIG. 2B, the post module 252 can include a post detection module 254 and a post analysis module 256.

The post module 252 can facilitate determining that a post associated with a subject subscribed to by a user account has been presented via a resource of a social networking system, as discussed previously. In some implementations, the post module 252 can utilize the post detection module 254 to detect that a new post or content item has been presented, published, shared, or otherwise made available via the resource. Additionally, the post module 252 can utilize the post analysis module 256 to analyze, parse, or scan, etc., the post.

In some embodiments, determining that the post associated with the subject has been presented via the resource can further comprise determining that the post is associated with a keyword, defined topic, and/or entity that has been selected as the subject by the user account. In some implementations, determining that the post is associated with the keyword, defined topic, and/or entity can further comprise determining that the post is associated a string representing the keyword, a subtopic specified as being included with the defined topic, and/or an identifier for the entity.

In one example, the post analysis module 256 can parse or otherwise analyze at least a portion of text included in the post to determine whether or not the string that represents the keyword is included in the portion of text. If so, the post can be determined to be associated with the subject, assuming that the keyword has been selected as the subject.

Moreover, in some cases, the post analysis module 256 can utilize a system (e.g., a topic tagger system, a topic definition system, a topic relation system, an entity recognition system, an entity identification system, etc.) that determines which posts or content items are associated with a given topic or a given entity. In one example, the post analysis module 256 can analyze the post to determine whether or not the post discusses, mentions, tags, or is otherwise sufficiently related to a particular topic. If so, the post can be determined to be associated with the subject, assuming that the particular topic has been selected as the subject. In this example, if the particular topic is a “deals” topic, the post analysis module 256 can determine that the post is still associated with the subject (“deals”) if the post is sufficiently related to sales, discounts, coupons, or subtopics, etc. In a further example, the post analysis module 256 can analyze the post to determine whether or not the post discusses, mentions, tags, or is otherwise sufficiently related to a particular entity. If so, the post can be determined to be associated with the subject, assuming that the particular entity has been selected as the subject. In this example, if the particular entity is John Doe, the post analysis module 256 can determine that the post is still associated with the subject (John Doe) if the post is sufficiently related to a name, a nickname, a moniker, an identifying phrase, or another identifier of John Doe. Again, many variations are possible.

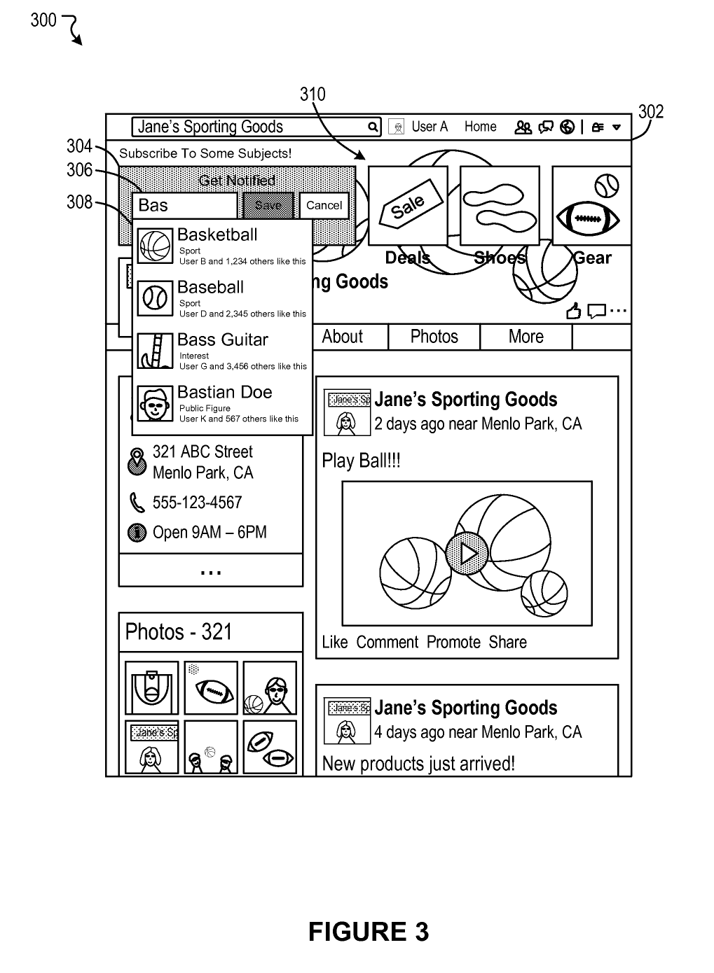

FIG. 3 illustrates an example scenario 300 associated with providing notifications based on subject subscription, according to an embodiment of the present disclosure. The scenario 300 illustrates an example interface 302 for an example social networking system resource, such as a page for a local business, “Jane's Sporting Goods”. As shown in the example of FIG. 3, the example interface 302 can include an interface portion 304 for subject subscription. The interface portion 304 can provide an input element 306, such as a text box, for a particular user or user account (e.g., User A) to input one or more characters to select a subject to which to subscribe.

In the example scenario 300, User A has inputted “Bas”. As a result, a list 308 of one or more subjects based on the inputted characters (“Bas”) can be provided via the interface portion 304. As shown in the list 308, a “Basketball” topic, a “Baseball” topic, a “Bass Guitar” topic, and an entity “Bastian Doe” can be provided based on the inputted “Bas”. Each of these can be a subject selectable by User A. If User A clicks on, taps on, or otherwise interacts with one of these listed subjects, User A can be subscribed to the selected subject. If, however, User A directly clicks on, taps on, or otherwise interacts with a confirm element, such as the “Save” button provided by the interface portion 304, then a keyword of “Bas” can be selected as the subject to which User A is subscribing.

Moreover, in some cases, a subset 310 of subjects available for subscription by User A can be presented via the resource, “Jane's Sporting Goods”. In some instances, if one or more subjects, out of the subset 310, have already been subscribed to by User A, then those one or more subjects can be identified, such as via graphical checkmark icons, emphasized text, etc. In some cases, a keyword subject can be presented with quotation marks around it. It should be appreciated that there can be many variations or other possibilities.

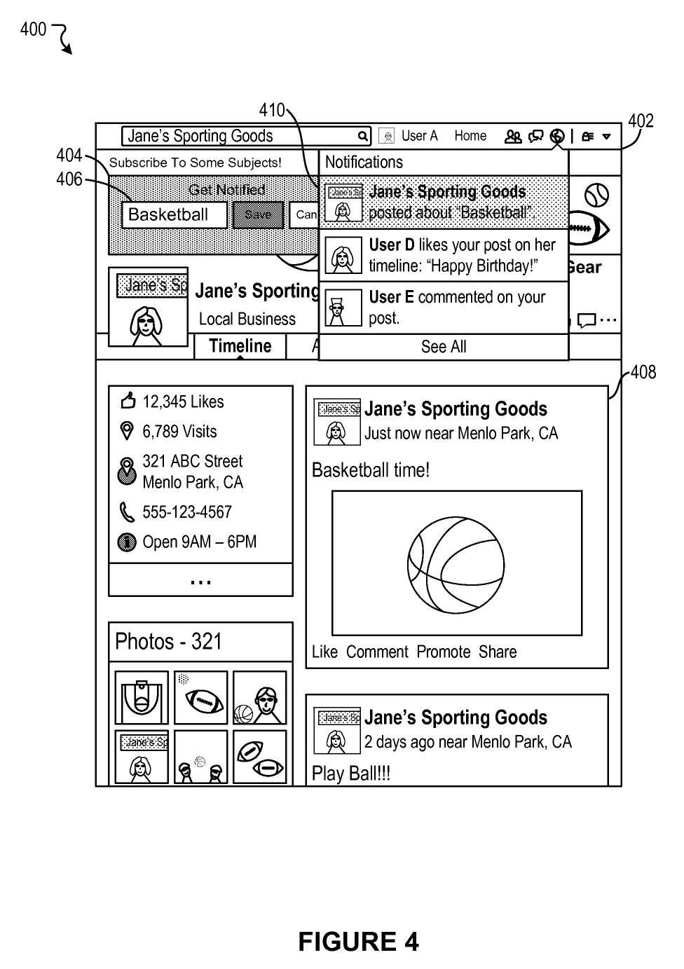

FIG. 4 illustrates an example scenario 400 associated with providing notifications based on subject subscription, according to an embodiment of the present disclosure. The example screenshot 400 illustrates an example interface 402, such as the example interface 302 of FIG. 3. In the example scenario 400 of FIG. 4, the interface 402 can be associated with a page for “Jane's Sporting Goods”. Furthermore, User A has inputted “Basketball” into a text box 406 of an interface portion 404 configured to facilitate subject subscription. In this example, User A has inputted “Basketball” as a keyword subject to which to subscribe.

Moreover, as shown, the page of “Jane's Sporting Good” has presented, provided, shared, or published a post 408 that includes the keyword subject (“Basketball”). As discussed above, the disclosed technology can determine that the post 408 presented at the page includes the keyword subject to which User A has subscribed. As a result, a notification 410 can be provided to User A. Again, many variations are possible.

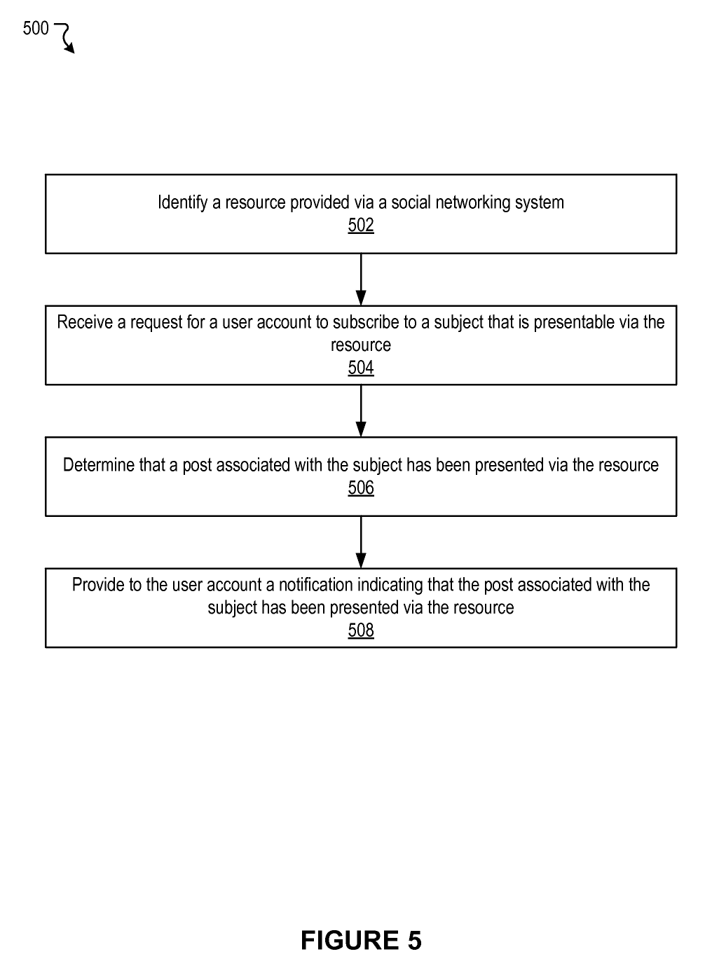

FIG. 5 illustrates an example method 500 associated with providing notifications based on subject subscription, according to an embodiment of the present disclosure. It should be appreciated that there can be additional, fewer, or alternative steps performed in similar or alternative orders, or in parallel, within the scope of the various embodiments unless otherwise stated.

At block 502, the example method 500 can identify a resource provided via a social networking system. At block 504, the example method 500 can receive a request for a user account to subscribe to a subject that is presentable via the resource. The subject can be included in a set of subjects available for subscription by the user account. At block 506, the example method 500 can determine that a post associated with the subject has been presented via the resource. At block 508, the example method 500 can provide to the user account a notification indicating that the post associated with the subject has been presented via the resource.

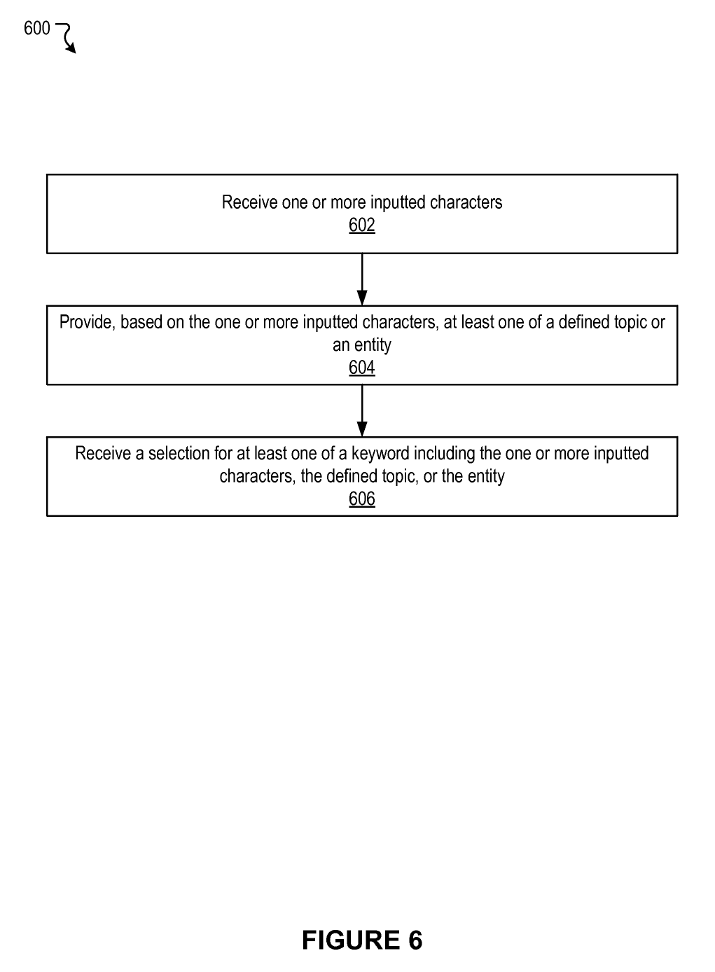

FIG. 6 illustrates an example method 600 associated with providing notifications based on subject subscription, according to an embodiment of the present disclosure. Again, it should be appreciated that there can be additional, fewer, or alternative steps performed in similar or alternative orders, or in parallel, within the scope of the various embodiments unless otherwise stated.

At block 602, the example method 600 can receive one or more inputted characters. At block 604, the example method 600 can provide, based on the one or more inputted characters, at least one of a defined topic or an entity. At block 606, the example method 600 can receive a selection for at least one of a keyword including the one or more inputted characters, the defined topic, or the entity. The request for the user account to subscribe to the subject can be based on the selection.

In some embodiments, the disclosed technology can provide various statistics, metadata, signals, and/or other information. In one example, the disclosed technology can indicate to the user which of his or her friends or how many friends have subscribed to certain subjects, as long as such indications are compliant with various privacy settings and preferences. In another example, the disclosed technology can indicate to the resource (or a representative/administrator thereof) which users have subscribed to which subjects, how many users have subscribed to certain subjects, which subjects have been subscribed to by users, and/or other analytical information. Also, it is important to note that the disclosed technology avoids divulging private information.

In some implementations, the subjects suggested to the user (or user account) can be ranked, such as based on relevancy to the user. In some instances, content presented via a feed to the user can be ranked based on (i.e., based at least in part on) the subjects to which the user has subscribed. Moreover, in some embodiments, the resource (or an admin/representative thereof) can send a message such as a post or an email asking users to subscribe to some subjects (e.g., predefined topics and/or entities). In one example, a page resource for a movie can create a post for advertising or promoting the movie. In this example, a user can click on or tap on the post (or a link in the post) to subscribe to a provided subject, such as a keyword “release”. As a result, the user can be notified when, on the release date of the movie, the movie page resource publishes a post that is associated with and includes the subject or keyword “release”.

It is contemplated that there can be many other uses, applications, features, possibilities, and/or variations associated with the various embodiments of the present disclosure. For example, in some cases, user can choose whether or not to opt-in to utilize the disclosed technology. The disclosed technology can also ensure that various privacy settings and preferences are maintained and can prevent private information from being divulged. In another example, various embodiments of the present disclosure can learn, improve, and/or be refined over time.

### Social Networking System

### Example Implementation

FIG. 7 illustrates a network diagram of an example system 700 that can be utilized in various scenarios, in accordance with an embodiment of the present disclosure. The system 700 includes one or more user devices 710, one or more external systems 720, a social networking system (or service) 730, and a network 750. In an embodiment, the social networking service, provider, and/or system discussed in connection with the embodiments described above may be implemented as the social networking system 730. For purposes of illustration, the embodiment of the system 700, shown by FIG. 7, includes a single external system 720 and a single user device 710. However, in other embodiments, the system 700 may include more user devices 710 and/or more external systems 720. In certain embodiments, the social networking system 730 is operated by a social network provider, whereas the external systems 720 are separate from the social networking system 730 in that they may be operated by different entities. In various embodiments, however, the social networking system 730 and the external systems 720 operate in conjunction to provide social networking services to users (or members) of the social networking system 730. In this sense, the social networking system 730 provides a platform or backbone, which other systems, such as external systems 720, may use to provide social networking services and functionalities to users across the Internet.

The user device 710 comprises one or more computing devices (or systems) that can receive input from a user and transmit and receive data via the network 750. In one embodiment, the user device 710 is a conventional computer system executing, for example, a Microsoft Windows compatible operating system (OS), Apple OS X, and/or a Linux distribution. In another embodiment, the user device 710 can be a computing device or a device having computer functionality, such as a smart-phone, a tablet, a personal digital assistant (PDA), a mobile telephone, a laptop computer, a wearable device (e.g., a pair of glasses, a watch, a bracelet, etc.), a camera, an appliance, etc. The user device 710 is configured to communicate via the network 750. The user device 710 can execute an application, for example, a browser application that allows a user of the user device 710 to interact with the social networking system 730. In another embodiment, the user device 710 interacts with the social networking system 730 through an application programming interface (API) provided by the native operating system of the user device 710, such as iOS and ANDROID. The user device 710 is configured to communicate with the external system 720 and the social networking system 730 via the network 750, which may comprise any combination of local area and/or wide area networks, using wired and/or wireless communication systems.

In one embodiment, the network 750 uses standard communications technologies and protocols. Thus, the network 750 can include links using technologies such as Ethernet, 702.11, worldwide interoperability for microwave access (WiMAX), 3G, 4G, CDMA, GSM, LTE, digital subscriber line (DSL), etc. Similarly, the networking protocols used on the network 750 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 750 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 710 may display content from the external system 720 and/or from the social networking system 730 by processing a markup language document 714 received from the external system 720 and from the social networking system 730 using a browser application 712. The markup language document 714 identifies content and one or more instructions describing formatting or presentation of the content. By executing the instructions included in the markup language document 714, the browser application 712 displays the identified content using the format or presentation described by the markup language document 714. For example, the markup language document 714 includes instructions for generating and displaying a web page having multiple frames that include text and/or image data retrieved from the external system 720 and the social networking system 730. In various embodiments, the markup language document 714 comprises a data file including extensible markup language (XML) data, extensible hypertext markup language (XHTML) data, or other markup language data. Additionally, the markup language document 714 may include JavaScript Object Notation (JSON) data, JSON with padding (JSONP), and JavaScript data to facilitate data-interchange between the external system 720 and the user device 710. The browser application 712 on the user device 710 may use a JavaScript compiler to decode the markup language document 714.

The markup language document 714 may also include, or link to, applications or application frameworks such as FLASH™ or Unity™ applications, the SilverLight™ application framework, etc.

In one embodiment, the user device 710 also includes one or more cookies 716 including data indicating whether a user of the user device 710 is logged into the social networking system 730, which may enable modification of the data communicated from the social networking system 730 to the user device 710.

The external system 720 includes one or more web servers that include one or more web pages 722a, 722b, which are communicated to the user device 710 using the network 750. The external system 720 is separate from the social networking system 730. For example, the external system 720 is associated with a first domain, while the social networking system 730 is associated with a separate social networking domain. Web pages 722a, 722b, included in the external system 720, comprise markup language documents 714 identifying content and including instructions specifying formatting or presentation of the identified content.

The social networking system 730 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 730 may be administered, managed, or controlled by an operator. The operator of the social networking system 730 may be a human being, an automated application, or a series of applications for managing content, regulating policies, and collecting usage metrics within the social networking system 730. Any type of operator may be used.

Users may join the social networking system 730 and then add connections to any number of other users of the social networking system 730 to whom they desire to be connected. As used herein, the term “friend” refers to any other user of the social networking system 730 to whom a user has formed a connection, association, or relationship via the social networking system 730. For example, in an embodiment, if users in the social networking system 730 are represented as nodes in the social graph, the term “friend” can refer to an edge formed between and directly connecting two user nodes.

Connections may be added explicitly by a user or may be automatically created by the social networking system 730 based on common characteristics of the users (e.g., users who are alumni of the same educational institution). For example, a first user specifically selects a particular other user to be a friend. Connections in the social networking system 730 are usually in both directions, but need not be, so the terms “user” and “friend” depend on the frame of reference. Connections between users of the social networking system 730 are usually bilateral (“two-way”), or “mutual,” but connections may also be unilateral, or “one-way.” For example, if Bob and Joe are both users of the social networking system 730 and connected to each other, Bob and Joe are each other's connections. If, on the other hand, Bob wishes to connect to Joe to view data communicated to the social networking system 730 by Joe, but Joe does not wish to form a mutual connection, a unilateral connection may be established. The connection between users may be a direct connection; however, some embodiments of the social networking system 730 allow the connection to be indirect via one or more levels of connections or degrees of separation.

In addition to establishing and maintaining connections between users and allowing interactions between users, the social networking system 730 provides users with the ability to take actions on various types of items supported by the social networking system 730. These items may include groups or networks (i.e., social networks of people, entities, and concepts) to which users of the social networking system 730 may belong, events or calendar entries in which a user might be interested, computer-based applications that a user may use via the social networking system 730, transactions that allow users to buy or sell items via services provided by or through the social networking system 730, and interactions with advertisements that a user may perform on or off the social networking system 730. These are just a few examples of the items upon which a user may act on the social networking system 730, and many others are possible. A user may interact with anything that is capable of being represented in the social networking system 730 or in the external system 720, separate from the social networking system 730, or coupled to the social networking system 730 via the network 750.

The social networking system 730 is also capable of linking a variety of entities. For example, the social networking system 730 enables users to interact with each other as well as external systems 720 or other entities through an API, a web service, or other communication channels. The social networking system 730 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 730. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 730 modifies edges connecting the various nodes to reflect the relationships and interactions.

The social networking system 730 also includes user-generated content, which enhances a user's interactions with the social networking system 730. User-generated content may include anything a user can add, upload, send, or “post” to the social networking system 730. For example, a user communicates posts to the social networking system 730 from a user device 710. Posts may include data such as status updates or other textual data, location information, images such as photos, videos, links, music or other similar data and/or media. Content may also be added to the social networking system 730 by a third party. Content “items” are represented as objects in the social networking system 730. In this way, users of the social networking system 730 are encouraged to communicate with each other by posting text and content items of various types of media through various communication channels. Such communication increases the interaction of users with each other and increases the frequency with which users interact with the social networking system 730.

The social networking system 730 includes a web server 732, an API request server 734, a user profile store 736, a connection store 738, an action logger 740, an activity log 742, and an authorization server 744. In an embodiment of the invention, the social networking system 730 may include additional, fewer, or different components for various applications. Other components, such as network interfaces, security mechanisms, load balancers, failover servers, management and network operations consoles, and the like are not shown so as to not obscure the details of the system.

The user profile store 736 maintains information about user accounts, including biographic, demographic, and other types of descriptive information, such as work experience, educational history, hobbies or preferences, location, and the like that has been declared by users or inferred by the social networking system 730. This information is stored in the user profile store 736 such that each user is uniquely identified. The social networking system 730 also stores data describing one or more connections between different users in the connection store 738. The connection information may indicate users who have similar or common work experience, group memberships, hobbies, or educational history. Additionally, the social networking system 730 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 730, such as non-person entities, buckets, cluster centers, images, interests, pages, external systems, concepts, and the like are also stored in the connection store 738.

The social networking system 730 maintains data about objects with which a user may interact. To maintain this data, the user profile store 736 and the connection store 738 store instances of the corresponding type of objects maintained by the social networking system 730. Each object type has information fields that are suitable for storing information appropriate to the type of object. For example, the user profile store 736 contains data structures with fields suitable for describing a user's account and information related to a user's account. When a new object of a particular type is created, the social networking system 730 initializes a new data structure of the corresponding type, assigns a unique object identifier to it, and begins to add data to the object as needed. This might occur, for example, when a user becomes a user of the social networking system 730, the social networking system 730 generates a new instance of a user profile in the user profile store 736, assigns a unique identifier to the user account, and begins to populate the fields of the user account with information provided by the user.

The connection store 738 includes data structures suitable for describing a user's connections to other users, connections to external systems 720 or connections to other entities. The connection store 738 may also associate a connection type with a user's connections, which may be used in conjunction with the user's privacy setting to regulate access to information about the user. In an embodiment of the invention, the user profile store 736 and the connection store 738 may be implemented as a federated database.

Data stored in the connection store 738, the user profile store 736, and the activity log 742 enables the social networking system 730 to generate the social graph that uses nodes to identify various objects and edges connecting nodes to identify relationships between different objects. For example, if a first user establishes a connection with a second user in the social networking system 730, user accounts of the first user and the second user from the user profile store 736 may act as nodes in the social graph. The connection between the first user and the second user stored by the connection store 738 is an edge between the nodes associated with the first user and the second user. Continuing this example, the second user may then send the first user a message within the social networking system 730. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 730 (or, alternatively, in an image maintained by another system outside of the social networking system 730). The image may itself be represented as a node in the social networking system 730. This tagging action may create edges between the first user and the second user as well as create an edge between each of the users and the image, which is also a node in the social graph. In yet another example, if a user confirms attending an event, the user and the event are nodes obtained from the user profile store 736, where the attendance of the event is an edge between the nodes that may be retrieved from the activity log 742. By generating and maintaining the social graph, the social networking system 730 includes data describing many different types of objects and the interactions and connections among those objects, providing a rich source of socially relevant information.

The web server 732 links the social networking system 730 to one or more user devices 710 and/or one or more external systems 720 via the network 750. The web server 732 serves web pages, as well as other web-related content, such as Java, JavaScript, Flash, XML, and so forth. The web server 732 may include a mail server or other messaging functionality for receiving and routing messages between the social networking system 730 and one or more user devices 710. The messages can be instant messages, queued messages (e.g., email), text and SMS messages, or any other suitable messaging format.

The API request server 734 allows one or more external systems 720 and user devices 710 to call access information from the social networking system 730 by calling one or more API functions. The API request server 734 may also allow external systems 720 to send information to the social networking system 730 by calling APIs. The external system 720, in one embodiment, sends an API request to the social networking system 730 via the network 750, and the API request server 734 receives the API request. The API request server 734 processes the request by calling an API associated with the API request to generate an appropriate response, which the API request server 734 communicates to the external system 720 via the network 750. For example, responsive to an API request, the API request server 734 collects data associated with a user, such as the user's connections that have logged into the external system 720, and communicates the collected data to the external system 720. In another embodiment, the user device 710 communicates with the social networking system 730 via APIs in the same manner as external systems 720.

The action logger 740 is capable of receiving communications from the web server 732 about user actions on and/or off the social networking system 730. The action logger 740 populates the activity log 742 with information about user actions, enabling the social networking system 730 to discover various actions taken by its users within the social networking system 730 and outside of the social networking system 730. Any action that a particular user takes with respect to another node on the social networking system 730 may be associated with each user's account, through information maintained in the activity log 742 or in a similar database or other data repository. Examples of actions taken by a user within the social networking system 730 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 730, the action is recorded in the activity log 742. In one embodiment, the social networking system 730 maintains the activity log 742 as a database of entries. When an action is taken within the social networking system 730, an entry for the action is added to the activity log 742. The activity log 742 may be referred to as an action log.

Additionally, user actions may be associated with concepts and actions that occur within an entity outside of the social networking system 730, such as an external system 720 that is separate from the social networking system 730. For example, the action logger 740 may receive data describing a user's interaction with an external system 720 from the web server 732. In this example, the external system 720 reports a user's interaction according to structured actions and objects in the social graph.

Other examples of actions where a user interacts with an external system 720 include a user expressing an interest in an external system 720 or another entity, a user posting a comment to the social networking system 730 that discusses an external system 720 or a web page 722a within the external system 720, a user posting to the social networking system 730 a Uniform Resource Locator (URL) or other identifier associated with an external system 720, a user attending an event associated with an external system 720, or any other action by a user that is related to an external system 720. Thus, the activity log 742 may include actions describing interactions between a user of the social networking system 730 and an external system 720 that is separate from the social networking system 730.

The authorization server 744 enforces one or more privacy settings of the users of the social networking system 730. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 720, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 720. One embodiment allows the specification of the set of entities to comprise an enumeration of entities. For example, the user may provide a list of external systems 720 that are allowed to access certain information. Another embodiment allows the specification to comprise a set of entities along with exceptions that are not allowed to access the information. For example, a user may allow all external systems 720 to access the user's work information, but specify a list of external systems 720 that are not allowed to access the work information. Certain embodiments call the list of exceptions that are not allowed to access certain information a “block list”. External systems 720 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 744 contains logic to determine if certain information associated with a user can be accessed by a user's friends, external systems 720, and/or other applications and entities. The external system 720 may need authorization from the authorization server 744 to access the user's more private and sensitive information, such as the user's work phone number. Based on the user's privacy settings, the authorization server 744 determines if another user, the external system 720, an application, or another entity is allowed to access information associated with the user, including information about actions taken by the user.

In some embodiments, the social networking system 730 can include a subject subscription module 746. The subject subscription module 746 can, for example, be implemented as the subject subscription module 102 of FIG. 1. As discussed previously, it should be appreciated that there can be many variations or other possibilities. For example, in some instances, the subject subscription module 746 (or at least a portion thereof) can be included in the user device 710. Other features of the subject subscription module 746 are discussed herein in connection with the subject subscription module 102.

### Hardware Implementation

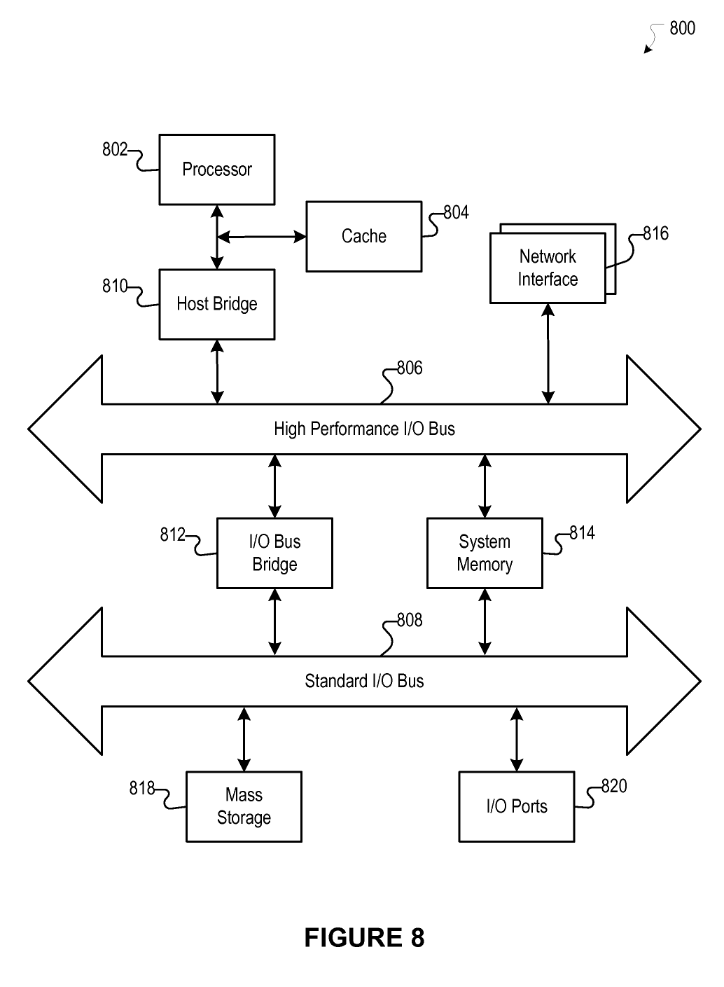

The foregoing processes and features can be implemented by a wide variety of machine and computer system architectures and in a wide variety of network and computing environments. FIG. 8 illustrates an example of a computer system 800 that may be used to implement one or more of the embodiments described herein in accordance with an embodiment of the invention. The computer system 800 includes sets of instructions for causing the computer system 800 to perform the processes and features discussed herein. The computer system 800 may be connected (e.g., networked) to other machines. In a networked deployment, the computer system 800 may operate in the capacity of a server machine or a client machine in a client-server network environment, or as a peer machine in a peer-to-peer (or distributed) network environment. In an embodiment of the invention, the computer system 800 may be the social networking system 730, the user device 710, and the external system 820, or a component thereof. In an embodiment of the invention, the computer system 800 may be one server among many that constitutes all or part of the social networking system 730.

The computer system 800 includes a processor 802, a cache 804, and one or more executable modules and drivers, stored on a computer-readable medium, directed to the processes and features described herein. Additionally, the computer system 800 includes a high performance input/output (I/O) bus 806 and a standard I/O bus 808. A host bridge 810 couples processor 802 to high performance I/O bus 806, whereas I/O bus bridge 812 couples the two buses 806 and 808 to each other. A system memory 814 and one or more network interfaces 816 couple to high performance I/O bus 806. The computer system 800 may further include video memory and a display device coupled to the video memory (not shown). Mass storage 818 and I/O ports 820 couple to the standard I/O bus 808. The computer system 800 may optionally include a keyboard and pointing device, a display device, or other input/output devices (not shown) coupled to the standard I/O bus 808. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 800, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 800 are described in greater detail below. In particular, the network interface 816 provides communication between the computer system 800 and any of a wide range of networks, such as an Ethernet (e.g., IEEE 802.3) network, a backplane, etc. The mass storage 818 provides permanent storage for the data and programming instructions to perform the above-described processes and features implemented by the respective computing systems identified above, whereas the system memory 814 (e.g., DRAM) provides temporary storage for the data and programming instructions when executed by the processor 802. The I/O ports 820 may be one or more serial and/or parallel communication ports that provide communication between additional peripheral devices, which may be coupled to the computer system 800.

The computer system 800 may include a variety of system architectures, and various components of the computer system 800 may be rearranged. For example, the cache 804 may be on-chip with processor 802. Alternatively, the cache 804 and the processor 802 may be packed together as a “processor module”, with processor 802 being referred to as the “processor core”. Furthermore, certain embodiments of the invention may neither require nor include all of the above components. For example, peripheral devices coupled to the standard I/O bus 808 may couple to the high performance I/O bus 806. In addition, in some embodiments, only a single bus may exist, with the components of the computer system 800 being coupled to the single bus. Moreover, the computer system 800 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 800 that, when read and executed by one or more processors, cause the computer system 800 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 800, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 802. Initially, the series of instructions may be stored on a storage device, such as the mass storage 818. However, the series of instructions can be stored on any suitable computer readable storage medium. Furthermore, the series of instructions need not be stored locally, and could be received from a remote storage device, such as a server on a network, via the network interface 816. The instructions are copied from the storage device, such as the mass storage 818, into the system memory 814 and then accessed and executed by the processor 802. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 800 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
identifying, by a computing system, a resource provided via a social networking system;
receiving, by the computing system, a request for a user account to subscribe to a subject that is presentable via the resource, the subject being included in a set of subjects available for subscription by the user account;
determining, by the computing system, that a post associated with the subject has been presented via the resource; and
providing, by the computing system, to the user account a notification indicating that the post associated with the subject has been presented via the resource.

2. The computer-implemented method of claim 1, wherein receiving the request for the user account to subscribe to the subject further comprises:
receiving one or more inputted characters;
providing, based on the one or more inputted characters, at least one of a defined topic or an entity; and
receiving a selection for at least one of a keyword including the one or more inputted characters, the defined topic, or the entity, wherein the request for the user account to subscribe to the subject is based on the selection.

3. The computer-implemented method of claim 2, wherein determining that the post associated with the subject has been presented via the resource further comprises:
determining that the post is associated with the at least one of the keyword including the one or more inputted characters, the defined topic, or the entity.

4. The computer-implemented method of claim 3, wherein determining that the post is associated with the at least one of the keyword including the one or more inputted characters, the defined topic, or the entity further comprises:
determining that the post is associated with at least one of a string representing the keyword, a subtopic specified as being included with the defined topic, or an identifier for the entity.

5. The computer-implemented method of claim 1, further comprising:
presenting, via the resource, a subset of the set of subjects available for subscription by the user account; and
identifying one or more subjects, out of the subset, to which the user account has subscribed.

6. The computer-implemented method of claim 1, wherein one or more subjects in the set of subjects are based on a category of the resource.

7. The computer-implemented method of claim 1, wherein one or more subjects in the set of subjects are specified by the resource.

8. The computer-implemented method of claim 1, wherein the resource includes at least one of a page within the social networking system, a group within the social networking system, an event within the social networking system, or an application within the social networking system.

9. The computer-implemented method of claim 1, wherein the notification is provided via at least one of the social networking system or a message system, and wherein the notification provides at least one of access to the post or access to a portion of the resource that presents the post.

10. The computer-implemented method of claim 1, wherein the notification is provided in real-time.

11. A system comprising:
at least one processor; and
a memory storing instructions that, when executed by the at least one processor, cause the system to perform:
identifying a resource provided via a social networking system;
receiving a request for a user account to subscribe to a subject that is presentable via the resource, the subject being included in a set of subjects available for subscription by the user account;
determining that a post associated with the subject has been presented via the resource; and
providing to the user account a notification indicating that the post associated with the subject has been presented via the resource.

12. The system of claim 11, wherein receiving the request for the user account to subscribe to the subject further comprises:
receiving one or more inputted characters;
providing, based on the one or more inputted characters, at least one of a defined topic or an entity; and
receiving a selection for at least one of a keyword including the one or more inputted characters, the defined topic, or the entity, wherein the request for the user account to subscribe to the subject is based on the selection.

13. The system of claim 12, wherein determining that the post associated with the subject has been presented via the resource further comprises:
determining that the post is associated with the at least one of the keyword including the one or more inputted characters, the defined topic, or the entity.

14. The system of claim 13, wherein determining that the post is associated with the at least one of the keyword including the one or more inputted characters, the defined topic, or the entity further comprises:
determining that the post is associated with at least one of a string representing the keyword, a subtopic specified as being included with the defined topic, or an identifier for the entity.

15. The system of claim 11, wherein the notification is provided via at least one of the social networking system or a message system, and wherein the notification provides at least one of access to the post or access to a portion of the resource that presents the post.

16. A non-transitory computer-readable storage medium including instructions that, when executed by at least one processor of a computing system, cause the computing system to perform:
identifying a resource provided via a social networking system;
receiving a request for a user account to subscribe to a subject that is presentable via the resource, the subject being included in a set of subjects available for subscription by the user account;
determining that a post associated with the subject has been presented via the resource; and
providing to the user account a notification indicating that the post associated with the subject has been presented via the resource.

17. The non-transitory computer-readable storage medium of claim 16, wherein receiving the request for the user account to subscribe to the subject further comprises:
receiving one or more inputted characters;
providing, based on the one or more inputted characters, at least one of a defined topic or an entity; and
receiving a selection for at least one of a keyword including the one or more inputted characters, the defined topic, or the entity, wherein the request for the user account to subscribe to the subject is based on the selection.

18. The non-transitory computer-readable storage medium of claim 17, wherein determining that the post associated with the subject has been presented via the resource further comprises:
determining that the post is associated with the at least one of the keyword including the one or more inputted characters, the defined topic, or the entity.

19. The non-transitory computer-readable storage medium of claim 18, wherein determining that the post is associated with the at least one of the keyword including the one or more inputted characters, the defined topic, or the entity further comprises:
determining that the post is associated with at least one of a string representing the keyword, a subtopic specified as being included with the defined topic, or an identifier for the entity.

20. The non-transitory computer-readable storage medium of claim 16, wherein the notification is provided via at least one of the social networking system or a message system, and wherein the notification provides at least one of access to the post or access to a portion of the resource that presents the post.
